(19) United States
(12) Patent Application Publication
(10) Pub. No.: US 2014/0373647 A1
(43) Pub. Date: Dec. 25, 2014

(54) LIFTING MOTION EVALUATION

(71) Applicant: Target Brands, Inc., Minneapolis, MN (US)

(72) Inventors: Nicole M. Stengle, Minneapolis, MN (US); Deborah Ann Bowles, Prior Lake, MN (US); Joseph D. Rothbauer, Princeton, MN (US)

(21) Appl. No.: 13/922,990

(22) Filed: Jun. 20, 2013

(51) Int. Cl. A63B 69/00; G01C 1/00

(52) U.S. Cl. CPC A63B 69/00; G01C 1/00
USPC 73/865.4

(57) ABSTRACT

Locations of a person's hand, shoulder and hip in three-dimensional space are received from a three-dimensional position sensing device. A shortest distance from the location of the person's hand to a line between the location of the person's shoulder and the location of the person's hip is determined. The shortest distance is compared to a threshold to determine if the person is overreaching. When it is determined that the person is overreaching, a user interface is provided to indicate that the person was overreaching. Additional location information for points on the person's body are used to determine if the person is performing a high lift, a low reach or a twist.

### BACKGROUND

In retail environments, employees are often required to lift objects to place them on shelves or to remove them from shelves. Retailers have found it helpful to train employees on how to lift properly.

The discussion above is merely provided for general background information and is not intended to be used as an aid in determining the scope of the claimed subject matter. The claimed subject matter is not limited to implementations that solve any or all disadvantages noted in the background.

### SUMMARY

Locations of a person's hand, shoulder and hip in three-dimensional space are received from a three-dimensional position sensing device. A shortest distance from the location of the person's hand to a line between the location of the person's shoulder and the location of the person's hip is determined. The shortest distance is compared to a threshold to determine if the person is overreaching. When it is determined that the person is overreaching, a user interface is provided to indicate that the person was overreaching.

Three-dimensional coordinates for a left hip point, a right hip point, a left shoulder point and a right shoulder point corresponding to a person's left hip, right hip, left shoulder and right shoulder are received. A translation is performed on the coordinates of at least two of the left hip point, the right hip point, the left shoulder point and the right shoulder point to form common plane coordinates for the left hip point, the right hip point, the left shoulder point and the right shoulder point, wherein the common plane coordinates are in a common plane. An angle is determined between a line from the common plane coordinates of the left hip point to the common plane coordinates of the right hip point and a line from the common plane coordinates of the left shoulder point to the common plane coordinates of the right shoulder point. The angle is compared to a threshold to determine if the person is twisting. When the person is determined to be twisting, a twisting event is recorded in memory.

A three-dimensional position sensor provides three-dimensional position information for a person's foot, the person's knee, and the person's hand. A processor executes instructions to perform steps that include receiving the three-dimensional position information for the person's foot, the person's knee and the person's hand, using the three-dimensional position information for the person's foot, the person's knee and the person's hand to determine an angle between a line from the person's knee to the person's foot and a line from the person's knee to the person's hand and determining if the angle indicates that the person is executing a low reach for an object. When it is determined that the angle indicates that the person is executing a low reach, storing an indication that the person has executed a low reach in memory.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a perspective view of a system used in lift training.

FIG. 2 provides a block diagram of elements used in a lift training system.

FIG. 3 provides a flow diagram of a method for lift training.

FIG. 4 shows a model of a person showing various points detected by a three-dimensional position sensor.

FIG. 5 shows a model of a person executing an excessive reach.

FIG. 6 shows a model of a person executing a reach that is not excessive.

FIG. 7 provides a flow diagram of a method of determining whether a reach is excessive.

FIG. 8 provides a diagram showing variables used to determine whether a reach is excessive.

FIG. 9 shows an example of a model indicating a distance between an elbow and a wrist.

FIG. 10 shows a model of a person executing a high lift.

FIG. 11 shows a model of a person executing a lift that is not a high lift.

FIG. 12 provides a flow diagram of a method of determining whether a person is executing a high lift.

FIG. 13 provides a diagram showing variables used to determine whether a user is executing a high lift.

FIG. 14 shows a model of a person executing a low reach.

FIG. 15 shows a model of a person executing a lift that is not a low reach.

FIG. 16 provides a flow diagram of a method of determining whether a person is executing a low reach.

FIG. 17 shows a diagram of variables used to determine whether a person is executing a low reach.

FIG. 18 provides a model of a person executing a twist.

FIG. 19 shows a model of a person not executing a twist.

FIG. 20 provides a flow diagram of a method of determining whether a person is executing a twist.

FIG. 21 provides a diagram showing variables used to determine whether a person is executing a twist.

FIG. 22 provides a further diagram of variables used to determine whether a person is executing a twist.

FIG. 23 provides an example of a training user interface in accordance with some embodiments.

FIG. 24 provides an example of a training report in accordance with some embodiments.

FIG. 25 provides a block diagram of a computing environment that may be used with various embodiments.

### DETAILED DESCRIPTION

Training an employee to lift properly has typically been done by having a trainer watch the employee as they execute various lifts. However, evaluation of the lifts is highly subjective and it can be difficult for the trainer to evaluate different aspects of the lift at the same time. For example, it can be difficult for a trainer to evaluate whether the employee is twisting and lifting too high at the same time. In accordance with the embodiments discussed below, a system is provided that tracks the three-dimensional coordinates of various body parts of an employee as they execute various lifts. The relative position of the body parts are used to determine whether the user is lifting properly. In particular, the system can automatically determine if the user is performing a high lift in which an object is lifted above the person's shoulder, a low reach in which the user's hands lift an object from below their knees, an overreach in which the user extends their hands away from their body too far, and a twist in which the user's shoulders turn relative to the user's hips. The system also provides user interfaces to provide feedback to the employee so that they may approve their lifting technique.

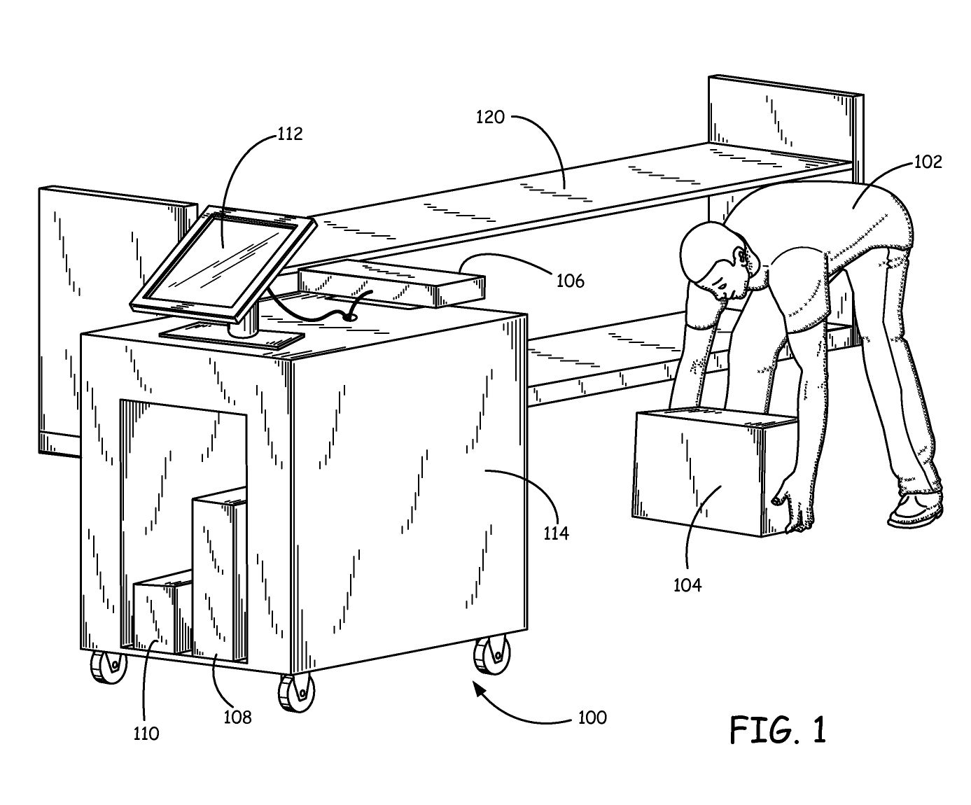

FIG. 1 provides a perspective view of a lift evaluation system 100 being used to evaluate the lifting technique of a person 102 as they lift an object 104 onto a shelf 120. Lift evaluation system 100 includes a three-dimensional position sensing device 106 (also referred to as a three-dimensional position sensor), a computing device 108, a power source 110 and a display 112 all supported by a movable cart 114. Three-dimensional position sensing device 106 uses infrared transmitters and detectors to detect the position of various parts of person 102's body as they execute a lift. This three-dimensional position information is provided to computing device 108, which uses the position information to determine whether the user is executing lifts properly. When user 102 executes an improper lift, computing device 108 records the improper lifting technique and can provide feedback through a user interface on display 112.

In accordance with some embodiments, power source 110 takes the form of a battery that provides power to three-dimensional position sensing device 106, computing device 108, and display 112. Alternatively, power source 110 may be a power cord connected to a power strip that display 112 and computing device 108 are plugged into. In accordance with some embodiments, three-dimensional position sensing device 106 receives its power through a combined power and data connection to computing device 108 such as a USB connection. In other embodiments, three-dimensional position sensing device 106 may be connected to power source 110 directly. One example of a three-dimensional position sensing device is the Kinect® sensor system provided by Microsoft Corporation.

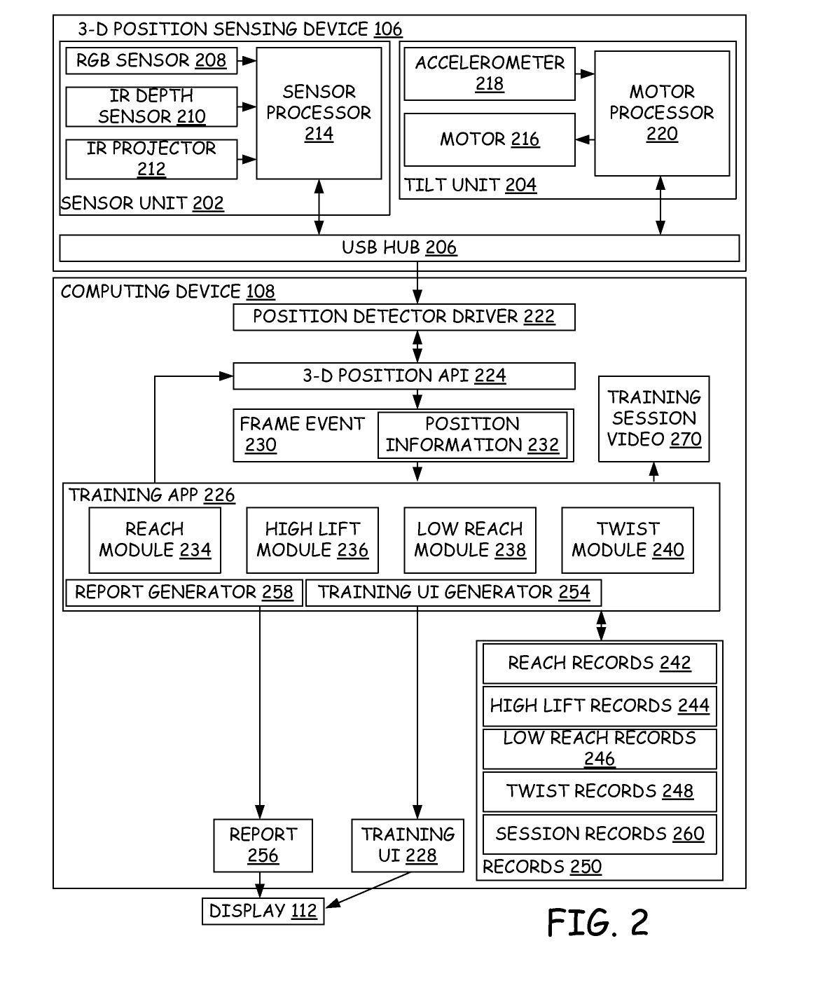

FIG. 2 provides a block diagram of elements in three-dimensional position sensing device 106 and computing device 108. As shown in FIG. 2, three-dimensional position sensing device 106 includes a sensor unit 202, a tilt unit 204 and a USB hub 206. Sensor unit 202 includes an RGB sensor or camera 208, an infrared (IR) depth sensor 210, IR projector 212 and a sensor processor 214. IR projector 212 emits an infrared signal that reflects off a person providing a reflected signal to IR depth sensor 210. RGB sensor 208 captures visible light to provide a video of the person in front of three-dimensional position sensing device 106. Sensor processor 214 uses the signal from IR depth sensor 210 to provide location information for objects within the view of IR depth sensor 210. In particular, sensor processor 214 is able to perform shape recognition to identify specific parts of the human body and to determine position information or locations for each of the body parts in three-dimensional space. This three-dimensional position information is provided by sensor processor 214 to USB hub 206 to be communicated to computing device 108.

Tilt unit 204 includes a motor 216 for tilting three-dimensional position sensing device 106 so that IR depth sensor 210 captures information about people in front of apparatus 106. Motor 216 is controlled by a motor processor 220 which activates motor 216 in response to information from sensor processor 214 to place a person in the field of view of apparatus 106. Motor processor 220 also uses accelerometer 218 to detect the current orientation of IR depth sensor 210. Motor processor 220 communicates with sensor processor 214 through USB hub 206.

Computing device 108 communicates with three-dimensional position sensing device 106 through a position detector driver 222 that is connected to USB hub 206. Position detector driver 222 in turn communicates with a three-dimensional (3-D) position application programming interface (API) 224, which provides a set of methods for controlling three-dimensional position sensing device 106 and requesting data from three-dimensional position sensing device 106. A training application 226 in computing device 108 interacts with 3-D position API 224 to collect data for determining how a person is lifting objects and provides user interfaces for conveying that information to a user through display 112.

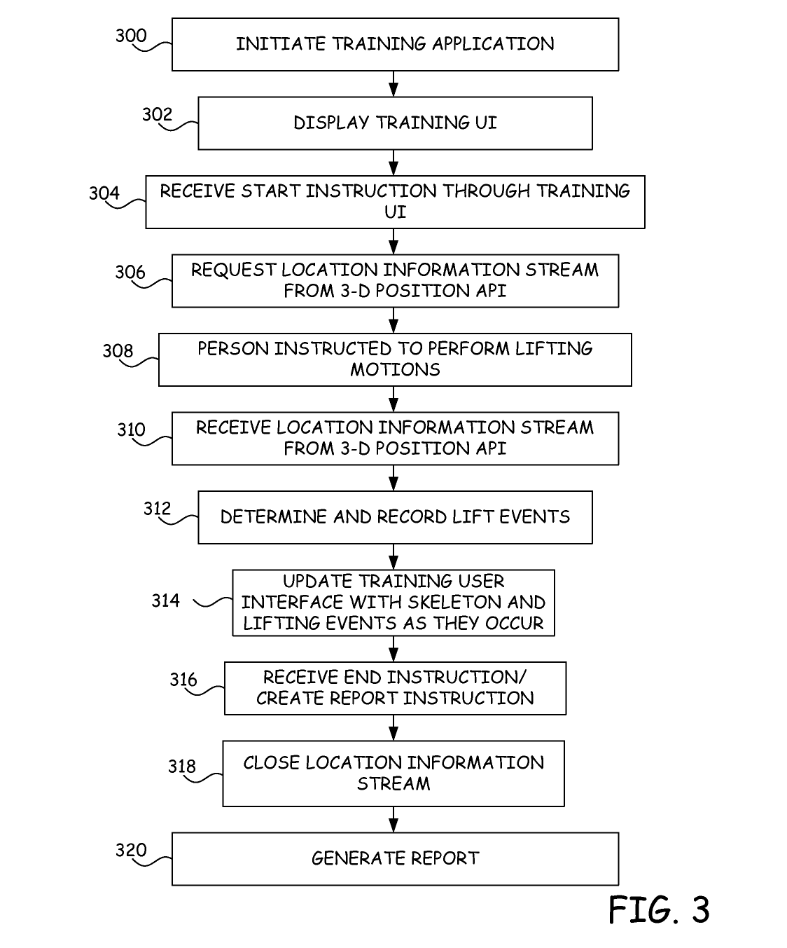

FIG. 3 provides a flow diagram for a method of performing a lift training session using the system of FIG. 2. In FIG. 3, training application 226 is initiated at step 300. At step 302, training user interface generator 254 of training application 226 generates training user interface 228, which is provided to display 112. Training user interface 228 includes a control that allows a user to start a training session and to adjust motor tilt unit 214 so that IR depth sensor 210 captures a person being trained. At step 304, training application 226 receives a start instruction through training user interface 228 that indicates that a training session is to be started. At step 306, training application 226 requests a location information stream from 3-D position API 224. The location information stream is a stream of frames where each frame contains position information for a collection of points on a person's body. The position information consists of three-dimensional coordinates that correspond to points on the person's body and indicate locations for different parts of the person's body in three-dimensional space.

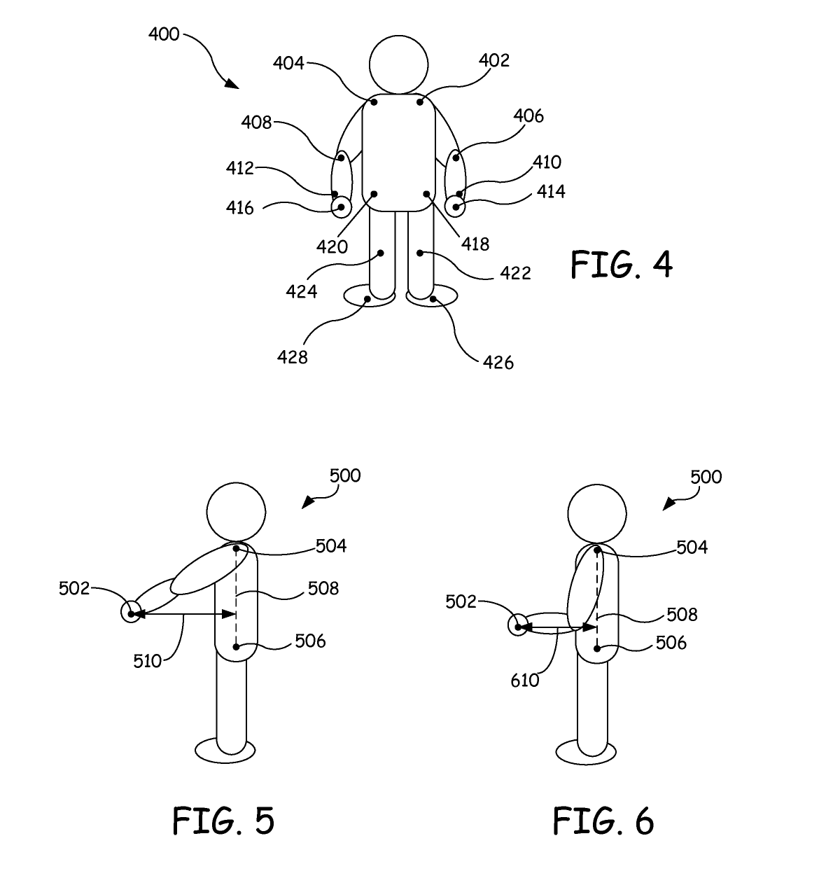

FIG. 4 provides a model 400 of a person showing points on a person's body for which position information is provided in each frame. The points include left shoulder point 402, right shoulder point 404, left elbow point 406, right elbow point 408, left wrist point 410, right wrist point 412, left hand point 414, right hand point 416, left hip point 418, right hip point 420, left knee point 422, right knee point 424, left foot point 426, and right foot point 428.

At step 308 of FIG. 3, the person being trained is instructed to perform various lifts. At step 310, training application 226 receives the location information stream from 3-D position API 224 in the form of a sequence of frame events 230 that each includes position information 232 for the body points of FIG. 4. At step 312, modules within training application 226 determine if various lift events have occurred and record the lift events in records 250. In particular, reach module 234, high lift module 236, low reach module 238 and twist module 240 determine if respective lift events occur and store information about the lift events in reach records 242, high lift records 244, low reach records 246, and twist records 248.

At step 314, training user interface 228 is updated with each frame event in the sequence of frame events 230. In accordance with some embodiments, each update of training user interface 228 involves changing a displayed graphical skeleton to depict the position of the person performing the various lifts in the current frame. Each update of training user interface 228 also involves displaying whether the person is performing one of a reach, a high lift, a low reach, a twist or a bend in the current frame. Further, each update of training user interface 228 can include updating and counts and rates for each of these lift types to indicate how many and at what rate the person is performing reaches, high lifts, low reaches, twists and bends. In some embodiments, an audio alert may be issued for during frames in which the person is performing at least one of a reach, a high lift, a low reach, a twist or a bend.

At step 316, training application 226 receives an end instruction through training user interface 228 indicating that the trainer or trainee wishes to end the training session. In accordance with one embodiment, the end instruction takes the form of a request for a report to be generated that provides information about the training session. In accordance with other embodiments, the end instruction takes the form of the trainee leaving the field of view of sensor unit 202. In response, at step 318, training application 226 closes the location information stream using a method provided by 3-D position API 224 and in response, three-dimensional position sensing device 106 discontinues sending position information to position detector driver 222 and 3-D position API 224.

At step 320, training application 226 generates a report 256 using a report generator 258. Report generator 258 generates report 256 by accessing records 250 and specifically by accessing each of reach records 242, high lift records 244, low reach records 246, and twist records 248. In addition, report generator 258 can access session records 260, which contain information about the current training session including information such as the trainee's name, the trainer's name, the time that the training session began, the time that the training session ended, and the date of the training session. An example of a report 256 generated by report generator 258 is discussed further below.

Overreach Events

In step 312, reach module 234 determines when a user is overreaching or performing an excessive reach during a lift. An overreach is considered to take place when a user's hands move too far away from the user's torso. FIG. 5 provides an example of a model 500 showing the model in an overreach position whereas FIG. 6 shows the model 500 in a satisfactory reach position. When a user lifts an object in an overreach or an excessive reach position, additional strain is placed on the user's back and legs. In FIG. 5, the model's hand 502 is a distance 510 from a line 508 between the shoulder 504 and hip 506 of model 500. In FIG. 6, the model's hand 502 is a distance 610 from line 508 between the shoulder 504 and the hip 506 of model 500. Distance 510 is longer than distance 610 and in fact exceeds a threshold distance used to determine when an overreach occurs.

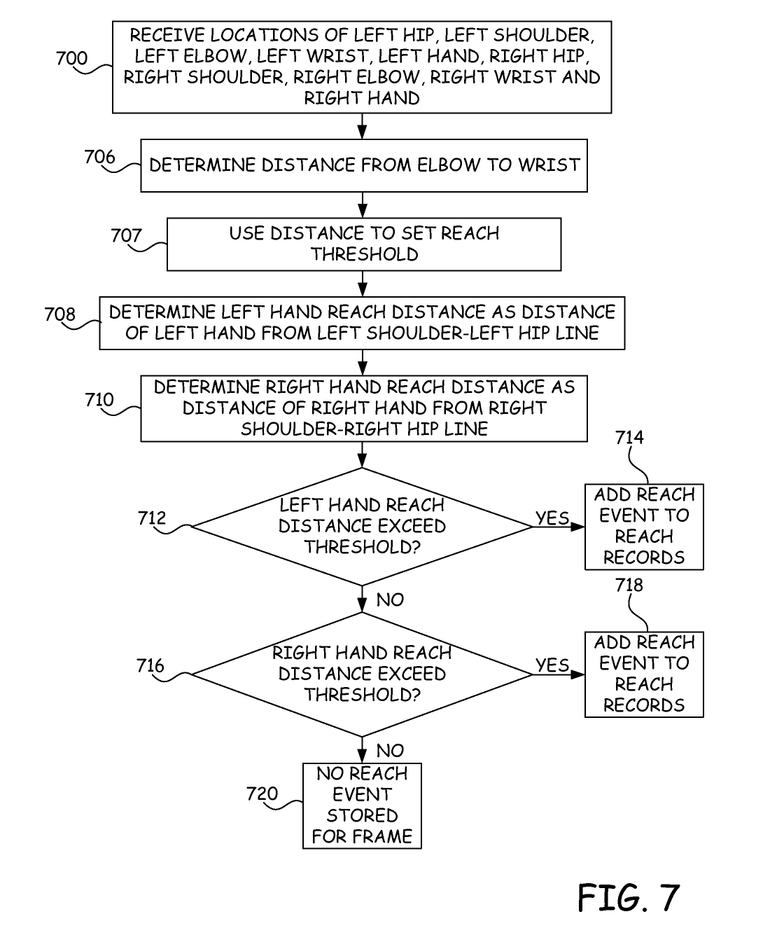

FIG. 7 provides a flow diagram of a method of determining when a user is performing an overreach or excessive reach during a lift. At step 700, reach module 234 receives the three-dimensional coordinates or locations of the person's left shoulder, left hip, left elbow, left wrist, left hand, right shoulder, right hip, right elbow, right wrist and right hand. At step 706, reach module 234 determines a distance D from the location of the left elbow to the location of the left wrist or from the location of the right elbow to the location of the right wrist of the person. FIG. 9 shows a diagram of a model arm 900 showing where distance D is measured from a location 902 of the wrist to a location 904 of the elbow. This distance can be calculated as:

D=\sqrt{(Wₓ−Eₓ)²+(W_{y}−E_{y})²+(W_{z}−E_{z})²} EQ. 1

where D is the distance between the elbow and the wrist, Wₓ, W_{y}, and W_{z} are the x, y, and z coordinates of the wrist, and Eₓ, E_{y}, and E_{z} are the x, y, and z coordinates of the user's elbow.

At step 707, the distance from the elbow to the wrist determined at step 706 is referred to as a reach standard and is used to set a reach threshold. This distance is used to set the reach threshold because taller people are able to lift objects further from their body without overreaching. Thus, a distance that may constitute an overreach for a shorter person will not constitute an overreach for a taller person. In accordance with one embodiment, the reach threshold is set as about 1.5 times or about one-hundred fifty percent of the reach standard. However, this threshold is only one example of a possible reach threshold.

At step 708, reach module 234 determines a left hand reach distance by determining the distance from the location of the person's left hand to a line from the location of the person's left shoulder to the location of the person's left hip. At step 710, reach module 234 determines a right hand reach distance by determining a distance from the person's right hand to a line from the person's right shoulder to the person's right hip.

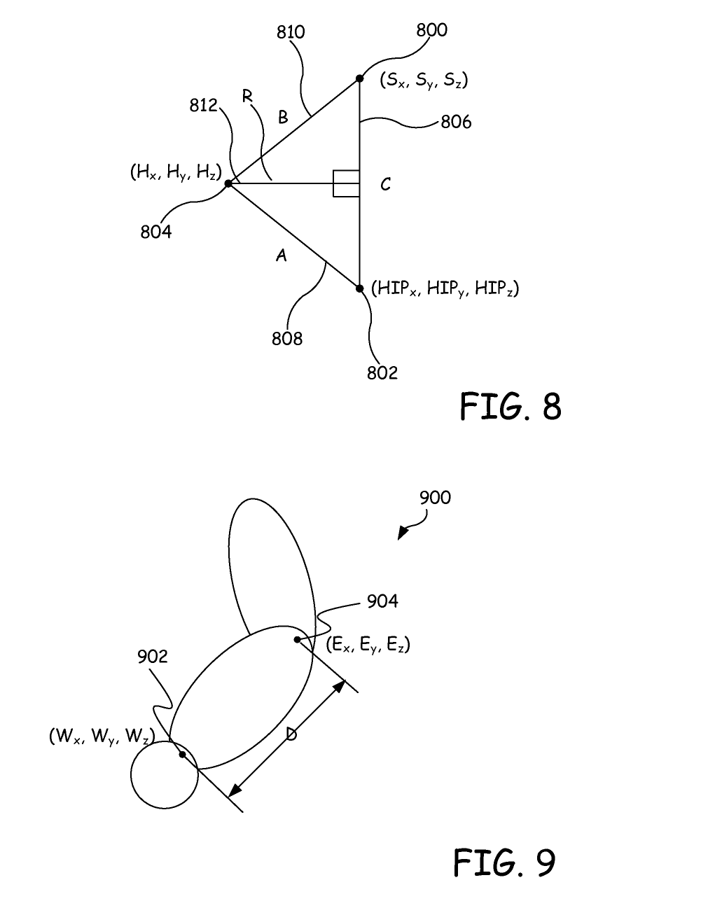

FIG. 8 provides a geometric diagram showing how the left hand reach distance and the right hand reach distance are determined in step 708 and 710. In FIG. 8, point 800 corresponds to the person's shoulder, point 802 corresponds to the person's hip and point 804 corresponds to the person's hand. For example, in step 708, point 800 corresponds to the person's left shoulder, point 802 corresponds to the person's left hip and point 804 corresponds to the person's left hand. In step 710, point 800 corresponds to the person's right shoulder, point 802 corresponds to the person's right hip and point 804 corresponds to the person's right hand.

Line 806 extends between shoulder point 800 and hip point 802 and is referred to as line C or a shoulder-hip line. Line 808 extends between hip point 802 and hand point 804 and is referred to as line A. Line 810 extends between shoulder point 800 and hand point 804 and is referred to as line B. Line 812 is perpendicular to line 806 and is referred to as line R. The length of line R, |R|, is the shortest distance between hand point 804 and line 806. In the discussion below, |R| is sometimes referred to simply as the distance between the person's hand and the line from the person's shoulder to the person's hip. To compute |R|, the following equations are used:

$$\begin{matrix}\vert R \vert = \vert A \vert * sin ( {cos}^{- 1} ( \frac{{\vert A \vert}^{2} - {\vert B \vert}^{2} + {\vert C \vert}^{2}}{2 \vert A \vert \vert C \vert} ) ) & EQ . 2 \\ \vert A \vert = \sqrt{{( {H}_{x} - {HIP}_{X} )}^{2} + {( {H}_{y} - {HIP}_{y} )}^{2} + {( {H}_{z} - {HIP}_{Z} )}^{2}} & EQ . 3 \\ \vert B \vert = \sqrt{{( {H}_{x} - {S}_{X} )}^{2} + {( {H}_{Y} - {S}_{Y} )}^{2} + {( {H}_{z} - {S}_{Z} )}^{2}} & EQ . 4 \\ \vert C \vert = \sqrt{{( {HIP}_{x} - {S}_{X} )}^{2} + {( {HIP}_{Y} - {S}_{Y} )}^{2} + {( {HIP}_{z} - {S}_{Z} )}^{2}} & EQ . 5\end{matrix}$$

where H_{X}, H_{Y}, and H_{Z} are the x, y, and z coordinates for hand point 804, S_{X}, S_{Y} and S_{Z} are the x, y, and z coordinates for shoulder point 800 and HIP_{X}, HIP_{Y}, and HIP_{Z} are the x, y, and z coordinates for hip point 802.

At step 712, if the left hand reach distance exceeds the threshold set at step 707, a reach event (also referred to as an overreach event) is added to reach records 242 at step 714. If the left hand reach distance does not exceed the threshold, reach module 234 determines if the right hand reach distance exceeds the threshold at step 716. If the right hand reach distance exceeds the threshold, then a reach event (also referred to as an overreach event) is added to reach records 242 at step 718. In accordance with some embodiments, the addition of a reach event to reach records 242 causes training user interface 228 to be updated to indicate that the user is performing a reach. If neither the left hand reach distance nor the right hand reach distance exceeds the threshold, no reach event is stored for the current frame of position information as indicated by step 720.

High Lift

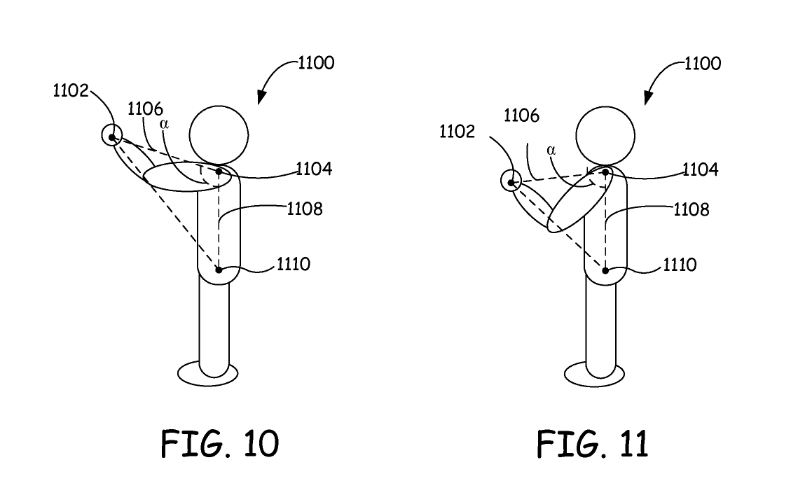

FIG. 10 provides an example of a user model 1100 showing the model in a high lift position with their hand 1102 above their shoulder 1104 and FIG. 11 provides a lift position that is not considered a high lift with model's hand 1100 below their shoulder 1102. In FIGS. 10 and 11, a line 1106 between hand 1102 and shoulder 1104 is at a lift angle α to a line 1108 between shoulder 1104 and hip 1110.

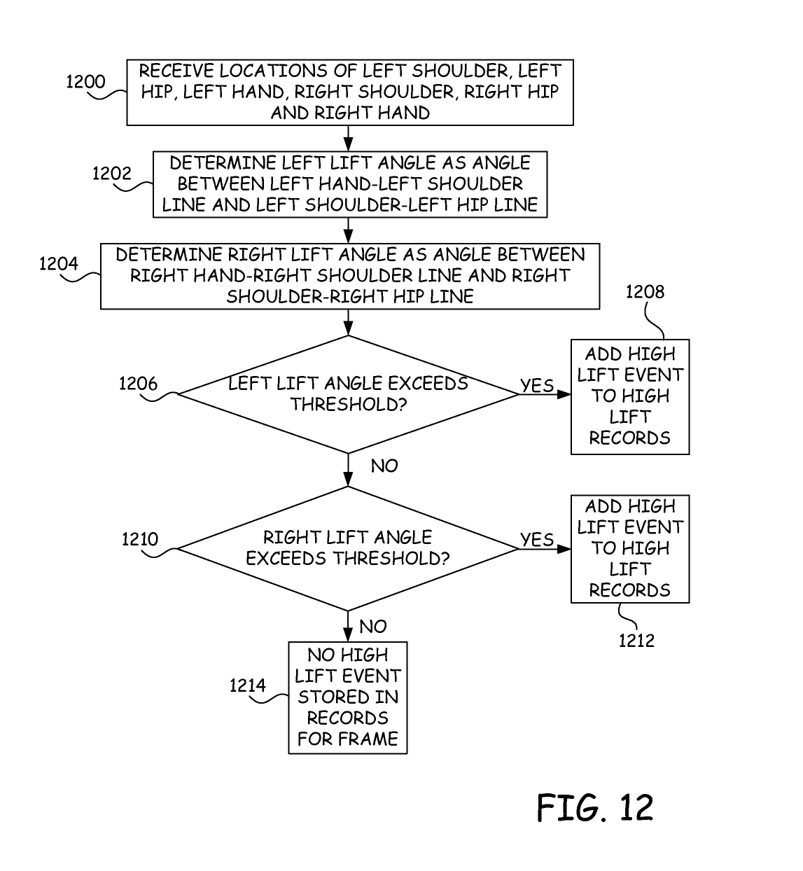

FIG. 12 provides a flow diagram of a method of determining when the user is executing a high lift. In step 1200, high lift module 236 receives the locations or coordinates of the person's left shoulder, left hip, left hand, right shoulder, right hip and right hand from position information 232 provided by three-dimensional position sensing device 106. At step 1202, high lift module 236 determines a left lift angle as the angle between a line from the left shoulder to the left hand and a line from left shoulder to the left hip. In step 1204, high lift module 236 determines a right lift angle as the angle between a line from the right shoulder to the right hand and a line from the right shoulder to the right hip.

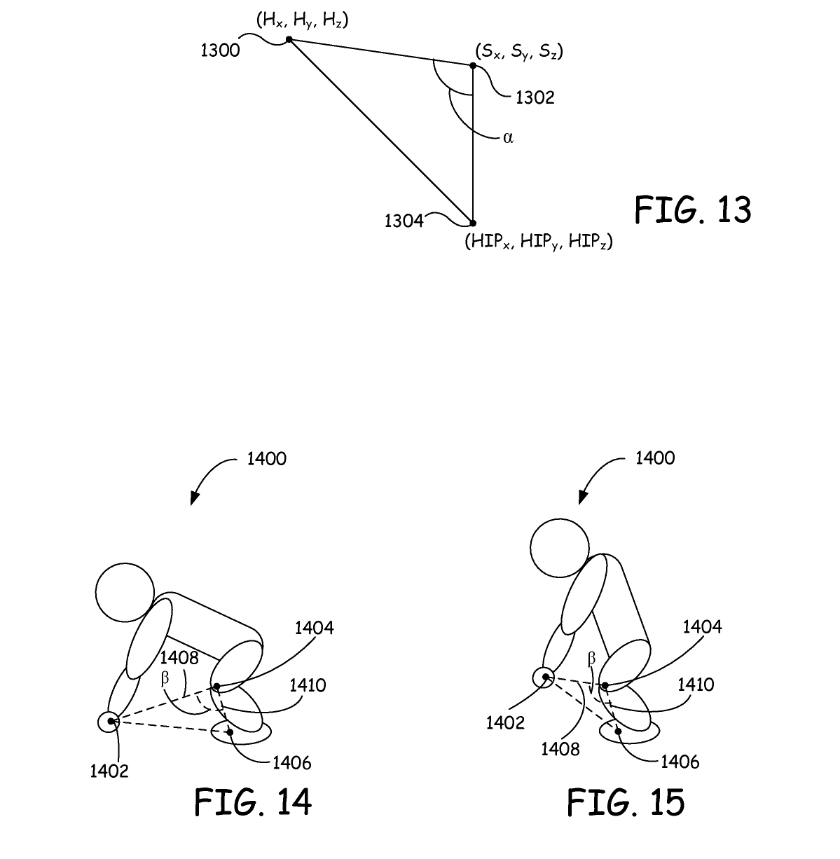

FIG. 13 provides a geometric diagram showing variables used to determine the left lift angle and the right lift angle. In FIG. 13, point 1300 corresponds to the person's hand, point 1302 corresponds to the person's shoulder and point 1304 corresponds to the person's hip. Angle α represents the angle between the line from the shoulder to the hand and the line from the shoulder to the hip. Angle α represents the left lift angle when hand point 1300 corresponds to the left hand, shoulder point 1302 corresponds to the left shoulder and hip point 1304 corresponds to the left hip in step 1202. Similarly, angle α represents the right lift angle when hand point 1300 corresponds to the right hand, shoulder point 1302 corresponds to the right shoulder and hip point 1304 corresponds to the right hip in step 1204. The lift angle may be computed as:

$$α = {cos}^{- 1} ( \frac{\begin{matrix}\begin{matrix}( {H}_{x} - {S}_{x} ) ( {HIP}_{X} - {S}_{X} ) + \\ ( {H}_{y} - {S}_{y} ) ( {HIP}_{y} - {S}_{y} ) +\end{matrix} \\ ( {H}_{z} - {S}_{z} ) ( {HIP}_{z} - {S}_{z} )\end{matrix}}{\begin{matrix}\sqrt{\begin{matrix}{( {HIP}_{x} - {S}_{x} )}^{2} + \\ {( {HIP}_{y} - {S}_{y} )}^{2} + {( {HIP}_{z} - {S}_{z} )}^{2}\end{matrix}} \\ \sqrt{\begin{matrix}{( {H}_{x} - {S}_{x} )}^{2} + \\ {( {H}_{y} - {S}_{y} )}^{2} + {( {H}_{z} - {S}_{z} )}^{2}\end{matrix}}\end{matrix}} ) \qquad EQ . 6$$

where α is the lift angle, where H_{X}, H_{Y}, and H_{Z} are the x, y, and z coordinates for hand point 1300, S_{X}, S_{Y} and S_{Z} are the x, y, and z coordinates for shoulder point 1302 and HIP_{X}, HIP_{Y}, and HIP_{Z} are the x, y, and z coordinates for hip point 1304. The lift angle α may alternatively be referred to as a hip-shoulder-hand angle or a hand-shoulder-hip angle.

In step 1206, high lift module 236 determines if the left lift angle exceeds a threshold. In accordance with one embodiment, the threshold is set at 90° such that when the left lift angle exceeds 90° the person's left hand is above their left shoulder. Those skilled in the art will recognize that other thresholds may be used. When the left lift angle exceeds the threshold, a high lift event is added to high lift records 244 at step 1208 by high lift module 236. When the left lift angle does not exceed the threshold, high lift module 236 determines if the right lift angle exceeds the threshold. For example, if the threshold is set to 90°, step 1210 involves determining whether the user's right hand is above their shoulder. If the right lift angle exceeds the threshold at step 1210, a high left event is added to high lift records 244 at step 1212 by high left module 236. In accordance with some embodiments, the addition of a high lift event to high lift records 244 causes training user interface 228 to be updated to indicate that the person is performing a high lift. When neither the left lift angle nor the right lift angle exceeds the threshold, no high lift event is stored in high lift records 244 for the present frame as indicated by step 1214.

Low Reach

FIG. 14 depicts a model 1400 of a person in a low reach position in which the model's hand 1402 is below the model's knee 1404. FIG. 15 provides a model of a person in which the model's hand 1402 is above the model's knee 1404 and thus the model is not performing a low reach. In FIGS. 14 and 15, a line 1408 between hand 1402 and knee 1404 is at a lift angle β to a line 1410 between knee 1404 and foot 1406.

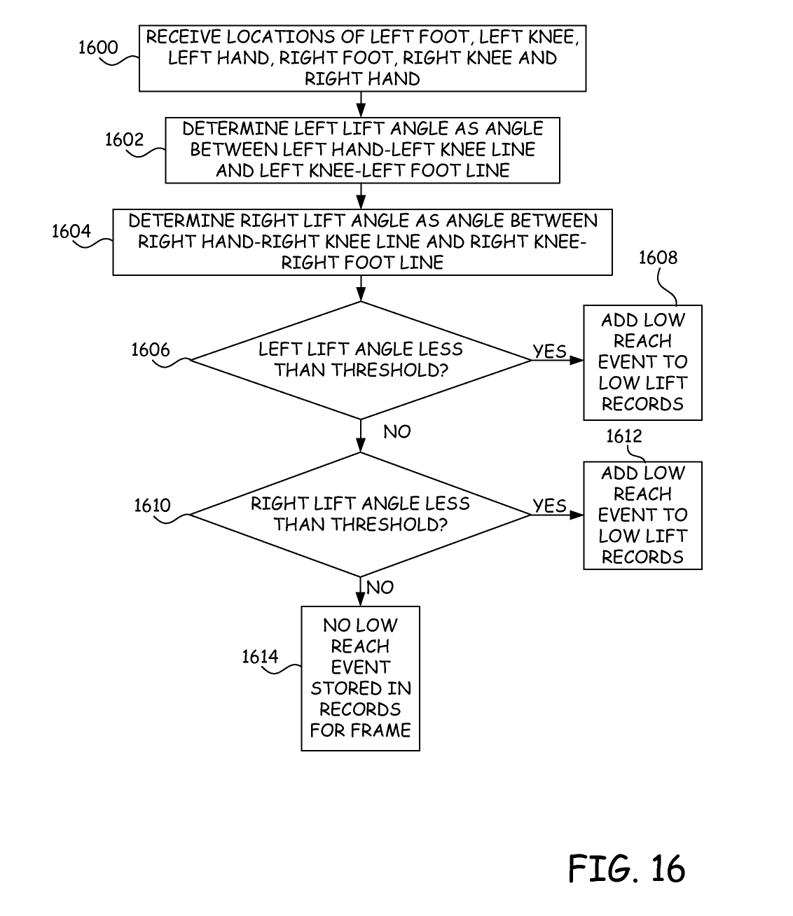

FIG. 16 provides a method used by low reach module 238 to determine whether a person is performing a low reach. In step 1600, low reach module 238 receives the locations of the person's left foot, left knee, left hand, right foot, right knee and right hand from position information 232 of a frame event 230.

At step 1602, low reach module 238 determines a left lift angle by determining the angle between a line from the user's left knee to their left hand and a line from the user's left knee to their left foot. At step 1604, low reach module 238 determines a right lift angle by determining the angle between a line from the person's right knee to their right hand and a line from the person's right knee to their right foot.

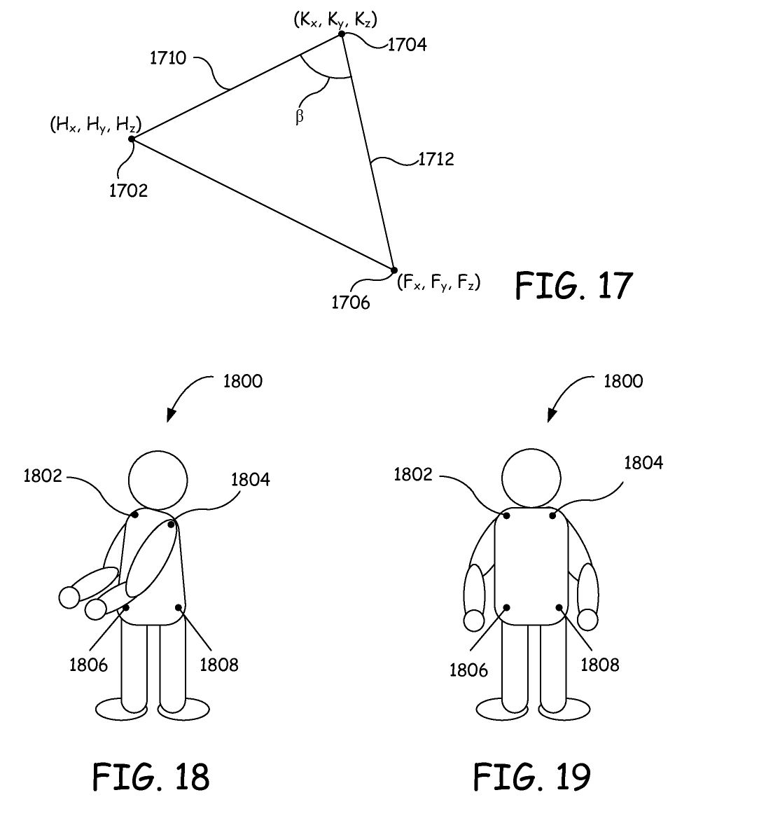

FIG. 17 provides a geometric diagram showing the variables used to determine the left lift angle and the right lift angle in steps 1602 and 1604. In FIG. 17, point 1702 corresponds to the person's hand, point 1704 corresponds to the person's knee and point 1706 corresponds to the person's foot. Lift angle 1708 is the angle between a line 1710 from the person's knee to the person's hand and a line 1712 from the person's knee to the person's foot. In step 1602, points 1702, 1704 and 1706 correspond to the left hand, left knee, and left foot of the person while in step 1602, points 1702, 1704 and 1706 correspond to the person's right hand, right knee and right foot respectively. Similarly, in step 1602, lift angle 1708 is the left lift angle and in step 1604, angle 1708 is the right lift angle. In accordance with one embodiment, lift angle 1708 is computed as:

$$β = {cos}^{- 1} ( \frac{\begin{matrix}\begin{matrix}( {H}_{x} - {K}_{x} ) ( {F}_{X} - {K}_{X} ) + \\ ( {H}_{y} - {K}_{y} ) ( {F}_{y} - {K}_{y} ) +\end{matrix} \\ ( {H}_{z} - {K}_{z} ) ( {F}_{z} - {K}_{z} )\end{matrix}}{\begin{matrix}\sqrt{{( {F}_{x} - {K}_{x} )}^{2} + {( {F}_{y} - {K}_{y} )}^{2} + {( {F}_{z} - {K}_{z} )}^{2}} \\ \sqrt{{( {H}_{x} - {K}_{x} )}^{2} + {( {H}_{y} - {K}_{y} )}^{2} + {( {H}_{z} - {K}_{z} )}^{2}}\end{matrix}} ) \qquad EQ . 7$$

where β is the lift angle, where H_{X}, H_{Y}, and H_{Z} are the x, y, and z coordinates for hand point 1702, K_{X}, K_{Y} and K_{Z} are the x, y, and z coordinates for knee point 1704 and F_{X}, F_{Y}, and F_{Z} are the x, y, and z coordinates for foot point 1706. The lift angle β may alternatively be referred to as a foot-knee-hand angle or a hand-knee-foot angle.

At step 1606, low reach module 238 determines if the left lift angle is less than a threshold. In accordance with one embodiment, the threshold for the low reach angle is set at 90° for both the left lift angle and the right lift angle. If the left lift angle is less than the threshold at step 1606, a low reach event is added to low reach records 246 at step 1608 by low reach module 238. At step 1610, low reach module 238 determines if the right lift angle is less than the threshold and if it is less than the threshold, low reach module 238 adds a low reach event to low reach records 246 at step 1612. In accordance with some embodiments, the addition of a low reach event to low reach records 246 causes training user interface 228 to be updated to indicate that the person is performing a low reach in the current frame. If neither the left lift angle nor the right lift angle is less than the threshold at steps 1606 and 1610, no low reach event is recorded in low reach records 246 for the frame as shown by step 1614.

Twist

In accordance with some embodiments, a twist occurs when a person's shoulders are turned relative to the person's hips. FIG. 18 provides a model 1800 of a person in which the model's shoulders 1802 and 1804 are twisted relative to the model's hips 1806 and 1808. FIG. 19 shows a model of a person in which the model's shoulders 1802 and 1804 are not twisted relative to the model's hips 1806 and 1808.

Determining whether a person's shoulders are twisted relative to the person's hips is complicated because the shoulders and hips reside in different planes and can be placed in different positions relative to each other when user bends at the waist.

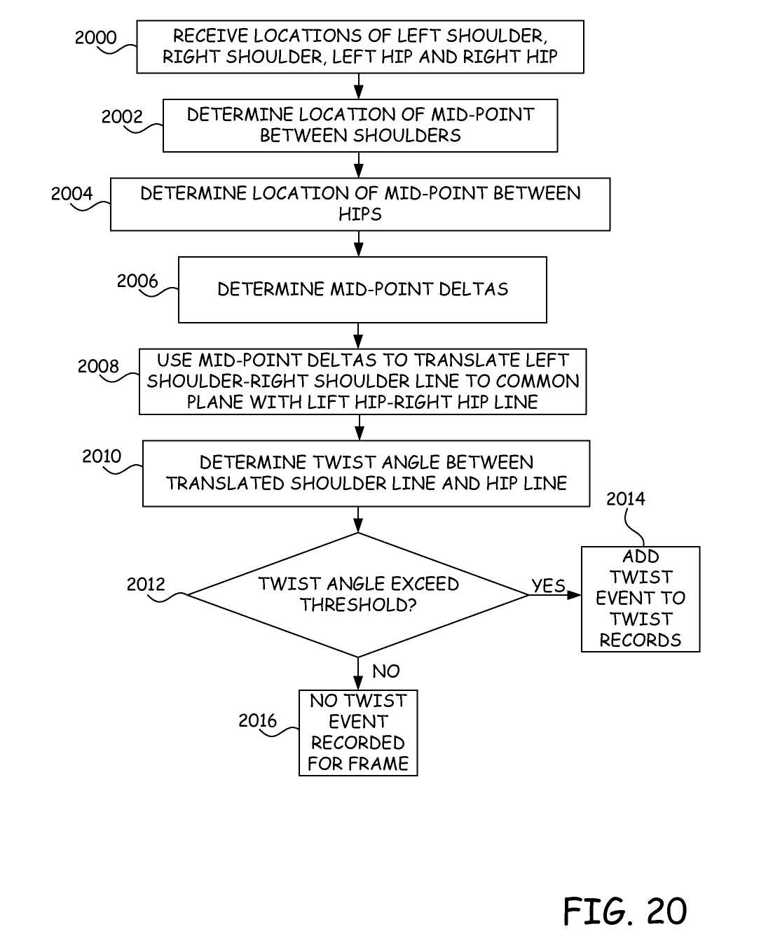

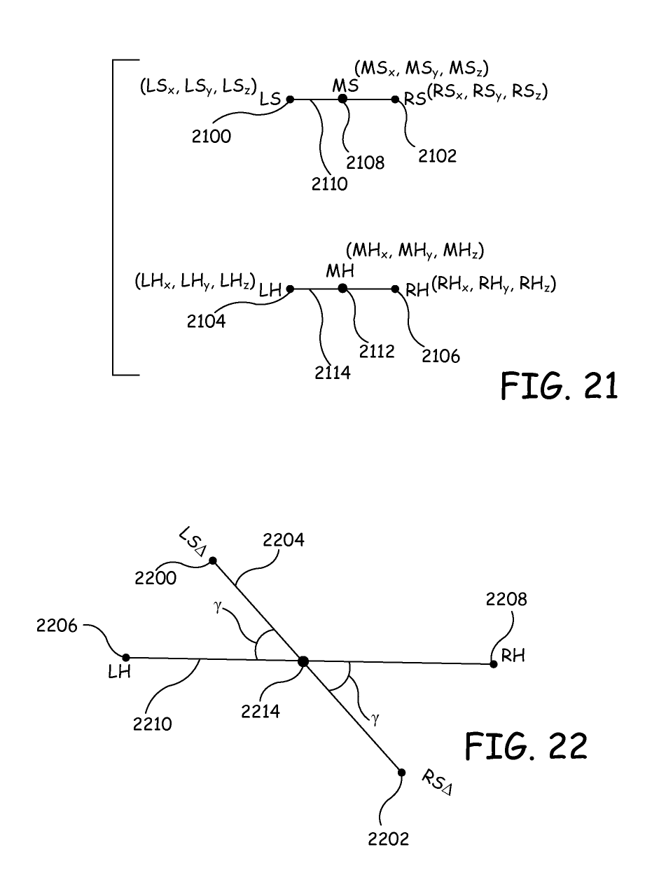

FIG. 20 provides a method for determining if a person is executing a twist. At step 2000, twist module 240 receives the locations of the person's left shoulder, right shoulder, left hip, and right hip from position information 232 for a frame event 230. In step 2002, twist module 240 determines the location of a mid-point between the person's left shoulder and their right shoulder. FIG. 21 provides a geometric diagram showing the position of the shoulder mid-point. In FIG. 21, point 2100 corresponds to the position of the person's left shoulder, point 2102 corresponds to the position of the person's right shoulder, point 2104 corresponds to the position of the user's left hip and point 2106 corresponds to the position of the person's right hip. Point 2108 corresponds to the mid-point between shoulder points 2100 and 2102 along the line 2110 connecting left shoulder 2100 to right shoulder 2102. In accordance with one embodiment, the coordinates of the shoulder mid-point MS are calculated as:

$$\begin{matrix}{MS}_{x} = \frac{{LS}_{x} - {RS}_{x}}{2} + {RS}_{x} & EQ . 8 \\ {MS}_{y} = \frac{{LS}_{y} - {RS}_{y}}{2} + {RS}_{y} & EQ . 9 \\ {MS}_{z} = \frac{{LS}_{z} - {RS}_{z}}{2} + {RS}_{z} & EQ . 10\end{matrix}$$

where LSₓ, LS_{y}, and LS_{z} are the x, y, and z coordinates of the left shoulder, RSₓ, RS_{y}, and RS_{z} are the x, y, and z coordinates of the right shoulder, and MSₓ, MS_{y}, and MS_{z} are the x, y, and z coordinates of the shoulder mid-point.

At step 2004, twist module 240 determines a location of a mid-point 2112 between left hip point 2104 and right hip point 2106 along line 2114, which connects left hip point 2104 and right hip point 2106. In accordance with one embodiment, the location of the hip mid-point MH is determined as:

$$\begin{matrix}{MH}_{x} = \frac{{LH}_{x} - {RH}_{x}}{2} + {RH}_{x} & EQ . 11 \\ {MH}_{y} = \frac{{LH}_{y} - {RH}_{y}}{2} + {RH}_{y} & EQ . 12 \\ {MH}_{z} = \frac{{LH}_{z} - {RH}_{z}}{2} + {RH}_{z} & EQ . 13\end{matrix}$$

where LHₓ, LH_{y}, and LH_{z} are the x, y, and z coordinates of the left hip, RHₓ, RH_{y}, and RH_{z} are the x, y, and z coordinates of the right hip and MHₓ, MH_{y}, and MH_{z} are the x, y, and z coordinates of the hip mid-point along the line between the left hip and the right hip.

At step 2006, twist module 240 determines mid-point deltas or differences that describe a vector between the hip mid-point MH 2112 and the shoulder mid-point MS 2108. The mid-point deltas describe how the mid-points would have to be shifted in order for the mid-points to coincide with each other. In accordance with one embodiment, the mid-point deltas are determined as:

ΔMₓ=MHₓ−MSₓ EQ. 14

ΔM_{Y}=MH_{Y}−MS_{Y} EQ. 15

ΔM_{Z}=MH_{Z}−MS_{Z} EQ. 16

At step 2008, twist module 240 uses the mid-point deltas as determined in step 2006 to translate either the shoulder points or the hip points so that the shoulder points and the hip points are in a common plane. Alternatively, all of the points could be translated so that they are placed in a common plane. Translating the shoulder points and/or the hip points so that the shoulder points and the hip points are in a common plane effectively translates line 2110 between the shoulder points and/or line 2114 between the hip points so that lines 2110 and 2114 are in a common plane. In accordance with one embodiment, the left shoulder point and the right shoulder point are translated into the plane of the left hip point and the right hip point to form a translated left shoulder point and a translated right shoulder point according to:

LSΔₓ=LSₓ+ΔMₓ EQ. 17

LSΔ_{y}=LS_{y}+ΔM_{y} EQ. 18

LSΔ_{z}=LS_{z}+ΔM_{z} EQ. 19

RSΔₓ=RSₓ+ΔMₓ EQ. 20

RSΔ_{y}=RS_{y}+ΔM_{y} EQ. 21

RSΔ_{z}=RS_{z}+ΔM_{z} EQ. 22

where LSΔₓ, LSΔ_{y}, and LSΔ_{z} are the x, y, and z coordinates of the translated left shoulder point, LSₓ, LS_{y}, and LS_{z} are the x, y, and z coordinates of the left shoulder point before translation, ΔMₓ, ΔM_{y}, and ΔM_{z} are the mid-point deltas for the x, y, and z coordinates, RSΔₓ, RSΔ_{y}, and RSΔ_{z} are the x, y, and z coordinates of the translated right shoulder point and RSₓ, RS_{y}, and RS_{z} are the x, y, and z coordinates of the right shoulder point before translation. The result of the translation is a set of common plane coordinates for the left shoulder, the right shoulder, the left hip and the right hip where all of the common plane coordinates reside in a common plane. In accordance with some embodiments, the coordinates for only one of the left shoulder or right shoulder are translated.

At step 2010, twist module 240 determines a twist angle between a line from the left translated shoulder point to the right translated shoulder point and a line between the left hip point and the right hip point. FIG. 22 provides a geometric diagram showing variables used to determine the twist angle. In FIG. 22, point 2200 corresponds to the translated left shoulder point, point 2202 corresponds to the translated right shoulder point, line 2204 is the line between the translated left shoulder point and the translated right shoulder point, point 2206 is the left hip point, point 2208 is the right hip point and line 2210 is the line between left hip point 2206 and right hip point 2208. An angle, γ, is the twist angle between line 2204 and line 2210. FIG. 22 also includes a mid-point 2214, which is the mid-point for line 2204 between translated left shoulder point 2200 and translated right shoulder point 2202 as well as being the mid-point for line 2210 between left hip point 2206 and right hip point 2208. Angle γ can also be considered to be the angle between a line from mid-point 2214 to right hip point 2208 and a line from mid-point 2214 to translated right shoulder point 2202. Angle γ is also the angle between a line from mid-point 2214 to translated left shoulder point 2200 and a line from mid-point 2214 to left hip point 2206.

In accordance with one embodiment, the twist angle γ is determined as:

$$γ = {cos}^{- 1} ( \frac{\begin{matrix}\begin{matrix}( {RH}_{x} - {MH}_{x} ) ( RS {Δ}_{X} - {MH}_{X} ) + \\ ( {RH}_{y} - {MH}_{y} ) ( RS {Δ}_{y} - {MH}_{y} ) +\end{matrix} \\ ( {RH}_{z} - {MH}_{z} ) ( RS {Δ}_{z} - {MH}_{z} )\end{matrix}}{\begin{matrix}\sqrt{\begin{matrix}{( RS {Δ}_{x} - {MH}_{x} )}^{2} + \\ {( RS {Δ}_{y} - {MH}_{y} )}^{2} + {( RS {Δ}_{z} - {MH}_{2} )}^{2}\end{matrix}} \\ \sqrt{\begin{matrix}{( {RH}_{x} - {MH}_{x} )}^{2} + \\ {( {RH}_{y} - {MH}_{y} )}^{2} + {( {RH}_{z} - {MH}_{z} )}^{2}\end{matrix}}\end{matrix}} ) \qquad EQ . 23$$

where γ is the angle between the line from the translated left shoulder point to the translated right shoulder point and the line from the left hip to the right hip in the common plane, RSΔₓ, RSΔ_{y}, and RSΔ_{z} are the x, y, and z coordinates of the translated right shoulder point, RHₓ, RH_{y}, and RH_{z} are the x, y, and z coordinates of the right hip and MHₓ, MH_{y}, and MH_{z} are the x, y, and z coordinates of the hip mid-point along the line between the left hip and the right hip. Note that twist angle γ is determined using only a single translated shoulder point. As such, the coordinates of both shoulder points do not need to be translated into the common plane.

At step 2012, twist module 240 determines if twist angle γ exceeds a threshold for a twist event. In accordance with one embodiment, the threshold is set to 10°. Those skilled in the art will recognize that other thresholds may be used. If twist angle γ exceeds the threshold at step 2012, twist module 240 adds a twist event (also referred to as an excessive twist) to twist records 248 at step 2014. In accordance with some embodiments, the addition of the twist event to twist records 248 causes training user interface 228 to be updated to indicate that the person is performing a twist. If the twist angle does not exceed the threshold, no twist event is stored in twist records 248 for the current frame as indicated by step 2016.

Training UI

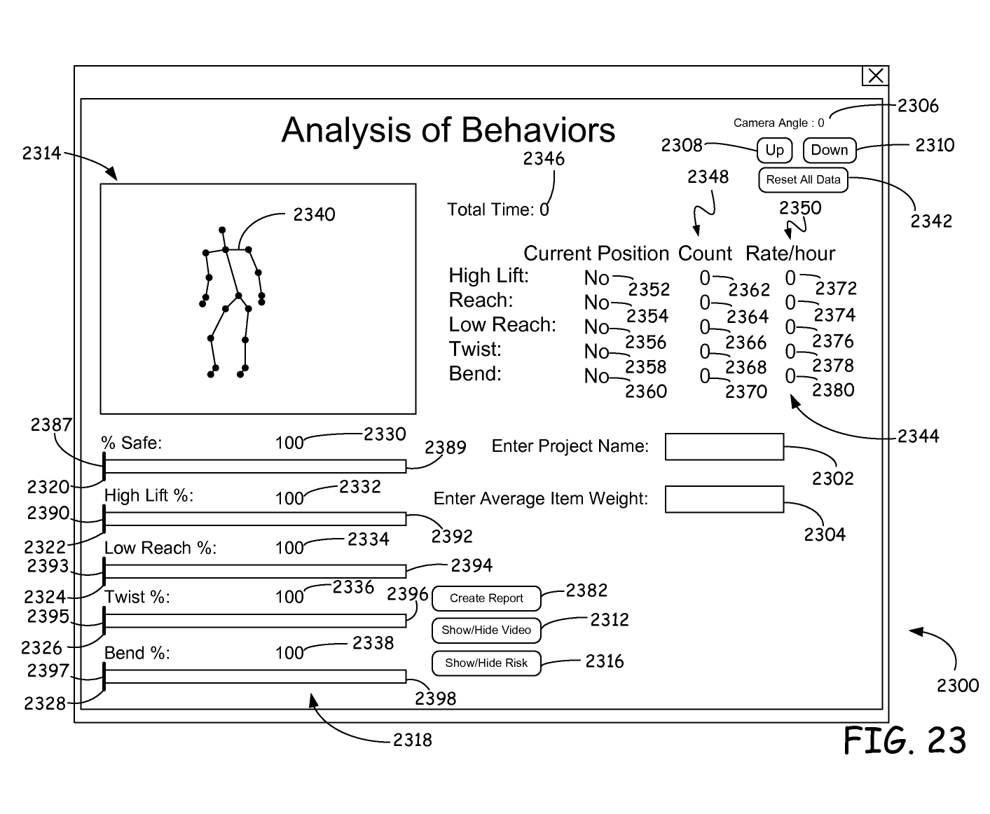

FIG. 23 provides an example 2300 of training user interface 228 of FIG. 2.

Before a training session begins, the trainer interacts with the user interface to place the training system in a desired state. For example, the trainer can insert a project name in a textbox 2302 to identify this training session and can insert an average item weight in a textbox 2304 to indicate the average weight of the objects that will be lifted during the training session. The trainer may also use Up control button 2308 and Down control button 2310 to change tilt unit 204 of sensing device 106 so that that the person being trained is captured within the view of IR depth sensor 210. The current angle of tilt unit 204 is shown as camera angle 2306 on user interface 2300. The trainer may use a Show/Hide Video button 2312 to control whether a video window 2314 is shown on user interface 2300. Video window 2314 contains a real time view of a skeleton 2340 which depicts the position of various joints of the person being trained using position information 232 of FIG. 2 for each frame. The trainer may also use Show/Hide Risk control 2316 to control whether a risk area 2318 is displayed on user interface 2300. Risk area 2318 includes dynamic bar graphs 2320, 2322, 2324, 2326 and 2328 and percentage values 2330, 2332, 2334, 2336 and 2338.

After the trainer has configured user interface 2300 as desired, the trainer selects Reset All Data button 2342 to initiate the training session. Pressing Reset All Data button 2342 causes Total Time indication 2346 to be reset to zero and each value in a metrics area 2344 to be reset to zero. In particular, each value in a count column 2348 of metrics area 2344 and a rate column 2350 of metrics area 2344 are set to zero when Reset All Data button 2342 is selected.

After Reset All Data button 2342 has been selected, the trainer instructs the trainee to begin performing various lift operations. As the trainee performs these lifts, reach module 234, high lift module 236, low reach module 238 and twist module 240 of FIG. 2 determine whether a high lift event, a reach event, a low reach event or a twist event are currently occurring. With each frame, a current position such as current positions 2352, 2354, 2356, 2358 and 2360 is updated. For example, if the trainee is currently performing a high lift, current position value 2352 is changed to “yes”. In addition, when one of these events takes place, the corresponding count, such as counts 2362, 2364, 2366, 2368 and 2370, is incremented by 1.

In addition, with each frame event, the rate of each lift type in column 2350 is updated. During each frame, the rate for a lift event is computed by dividing the count in count column 2348 for the lift event by the number of minutes in the total elapsed time 2346 divided by 60.

If risk area 2318 is displayed, dynamic bar graphs 2320, 2322, 2324, 2326 and 2328 and percentage values 2330, 2332, 2334, 2336 and 2338 are updated with each frame event.

High lift percentage value 2332 and dynamic bar graph 2322 indicate the percentage of women who can perform the high lifts that the trainee has performed thus far during the training. In one embodiment, the high lift percentage is calculated as:

$$High Lift \% = 161 - ( 4.4 * Avg . Weight ) + ( 0.0561 * \frac{Elapsed Time}{\# of High Lifts} ) - ( Avg . Reach * 3.33 ) \qquad EQ . 24$$

where Avg. Weight is the average weight in text box 2304, Elapsed Time is the total time 2346 in seconds, # of High Lifts is the count 2362 of High Lifts that have been performed and Avg. Reach is the average of the left hand reach and the right hand reach as determined above using Equation 2 for each frame. If the value computed for the high lift percentage using Equation 24 is greater than one hundred, the high lift percentage value is set to one hundred. Similarly, if the value computed for the high lift percentage using Equation 24 is less than zero, the high lift percentage value is set to zero.

Dynamic bar graph 2322 moves to the right in an inverse relationship to high lift percentage value 2332. When high lift percentage value 2332 is 100%, dynamic bar graph 2322 is at its furthest left at position 2390. When high lift percentage value 2332 is 0%, dynamic bar graph 2322 is at its furthest right at position 2392. In some embodiments, dynamic bar graph 2322 is colored such that it is green near position 2390, is yellow between position 2390 and position 2392 and is red near position 2392, thereby indicating that it is more desirable to have dynamic bar graph 2322 at position 2390 than at position 2392.

Low reach percentage value 2334 and dynamic bar graph 2324 indicate the percentage of women who can perform the low reaches that the trainee has performed thus far during the training. In one embodiment, the low reach percentage is calculated as:

$$Low Reach \% = 166 - ( 2.87 * Avg . Weight ) + ( 0.0489 * \frac{Elapsed Time}{\# of Low Reaches} ) - ( Avg . Reach * 3.56 ) \qquad EQ . 25$$

where Avg. Weight is the average weight in text box 2304, Elapsed Time is the total time 2346 in seconds, # of Low Reaches is the count 2364 of Low Reaches that have been performed and Avg. Reach is the average of the left hand reach and the right hand reach as determined above using Equation 2 for each frame. If the value computed for the low reach percentage using Equation 25 is greater than one hundred, the low reach percentage value is set to one hundred. Similarly, if the value computed for the low reach percentage using Equation 25 is less than zero, the low reach percentage value is set to zero.

Dynamic bar graph 2324 moves to the right in an inverse relationship to low reach percentage value 2334. When low reach percentage value 2334 is 100%, dynamic bar graph 2324 is at its furthest left position 2393. When low reach percentage value 2334 is 0%, dynamic bar graph 2324 is at its furthest right at position 2394. In some embodiments, dynamic bar graph 2324 is colored such that it is green near position 2393, is yellow between position 2393 and position 2394 and is red near position 2394, thereby indicating that it is more desirable to have dynamic bar graph 2324 at position 2393 than at position 2394.

Twist percentage value 2336 and dynamic bar graph 2326 indicate the percentage of women who can perform the twists that the trainee has performed thus far during the training. In one embodiment, the twist percentage is calculated as:

$$Twist \% = 160 - ( 3.8 * Avg . Weight ) + ( 0.06 * \frac{Elapsed Time}{\# of Twists} ) - ( Avg . Reach * 3.0 ) \qquad EQ . 26$$

where Avg. Weight is the average weight in text box 2304, Elapsed Time is the total time 2346 in seconds, # of Twists is the count 2366 of Twists that have been performed and Avg. Reach is the average of the left hand reach and the right hand reach as determined above using Equation 2 for each frame. If the value computed for the twist percentage using Equation 26 is greater than one hundred, the twist percentage value is set to one hundred. Similarly, if the value computed for the twist percentage using Equation 26 is less than zero, the twist percentage value is set to zero.

Dynamic bar graph 2326 moves to the right in an inverse relationship to twist percentage value 2336. When twist percentage value 2336 is 100%, dynamic bar graph 2326 is at its furthest left position 2395. When twist percentage value 2336 is 0%, dynamic bar graph 2326 is at its furthest right at position 2396. In some embodiments, dynamic bar graph 2326 is colored such that it is green near position 2395, is yellow between position 2395 and position 2396 and is red near position 2396, thereby indicating that it is more desirable to have dynamic bar graph 2326 at position 2395 than at position 2396.

Bend percentage value 2338 and dynamic bar graph 2328 indicate the percentage of women who can perform the bends that the trainee has performed thus far during the training. In one embodiment, the bend percentage is calculated as:

$$Bend \% = 160 - ( 3.8 * Avg . Weight ) + ( 0.06 * \frac{Elapsed Time}{\# of Bends} ) - ( Avg . Reach * 3.0 ) \qquad EQ . 27$$

where Avg. Weight is the average weight in text box 2304, Elapsed Time is the total time 2346 in seconds, # of Bends is the count 2368 of Bends that have been performed and Avg. Reach is the average of the left hand reach and the right hand reach as determined above using Equation 2 for each frame. In accordance with one embodiment, a bend is detected by training application 226 when an angle between a line from the trainee's knee to their hip and a line from the trainee's shoulder and their hip is less than one hundred fifty degrees while an angle between a line from the trainee's hip to the trainee's knee and a line from the trainee's ankle to the trainee's knee is greater than one hundred forty degrees. If the value computed for the bend percentage using Equation 27 is greater than one hundred, the bend percentage value is set to one hundred. Similarly, if the value computed for the bend percentage using Equation 27 is less than zero, the bend percentage value is set to zero.

Dynamic bar graph 2328 moves to the right in an inverse relationship to bend percentage value 2338. When bend percentage value 2338 is 100%, dynamic bar graph 2328 is at its furthest left position 2397. When bend percentage value 2338 is 0%, dynamic bar graph 2328 is at its furthest right at position 2397. In some embodiments, dynamic bar graph 2328 is colored such that it is green near position 2397, is yellow between position 2397 and position 2398 and is red near position 2398, thereby indicating that it is more desirable to have dynamic bar graph 2328 at position 2397 than at position 2398.

Safe percentage value 2330 and dynamic bar graph 2320 indicate the percentage of women who can perform the high lifts, low reaches, twists and bends that the trainee has performed thus far during the training. In one embodiment, the safe percentage is calculated as:

Safe %=((2*modified Twist Risk)+(2*modified Bend Risk)+high lift %+low reach %)/6 EQ. 28

where high lift % is the value computed in Equation 24, low reach % is the value computed in Equation 25, and modified Twist Risk and modified Bend Risk are computed as:

$$\begin{matrix}modified Twist Risk = 150 - ( 4.2 * Avg . Weight ) + ( 0.3 * \frac{Elapsed Time}{\# of Twists} ) - ( Avg . Reach * 3.2 ) & EQ . 29 \\ modified Bend Risk = 150 - ( 4.2 * Avg . Weight ) + ( 0.3 * \frac{Elapsed Time}{\# of Bends} ) - ( Avg . Reach * 3.2 ) & EQ . 30\end{matrix}$$

where Avg. Weight is the average weight in text box 2304, Elapsed Time is the total time 2346 in seconds, # of Twists is the count 2366 of Twists that have been performed, # of Bends is the count 2368 of Bends that have been performed and Avg. Reach is the average of the left hand reach and the right hand reach as determined above using Equation 2 for each frame. If the value computed for the modified Twist Risk or the modified Bend risk is greater than one hundred, the value is set to one hundred. Similarly, if the value computed for the modified Twist Risk or the modified Bend risk is less than zero, the value is set to zero.

Dynamic bar graph 2320 moves to the right in an inverse relationship to safe percentage value 2330. When safe percentage value 2330 is 100%, dynamic bar graph 2320 is at its furthest left position 2387. When safe percentage value 2330 is 0%, dynamic bar graph 2320 is at its furthest right at position 2389. In some embodiments, dynamic bar graph 2320 is colored such that it is green near position 2387, is yellow between position 2387 and position 2389 and is red near position 2389, thereby indicating that it is more desirable to have dynamic bar graph 2320 at position 2387 than at position 2389.

To end the training session, the trainee can either leave the field of view of sensing device 106 or the trainer can select create report button 2382. Selecting create report 2382 causes report generator 258 to generate report 256 using the counts and rates depicted in metrics area 2344.

Report

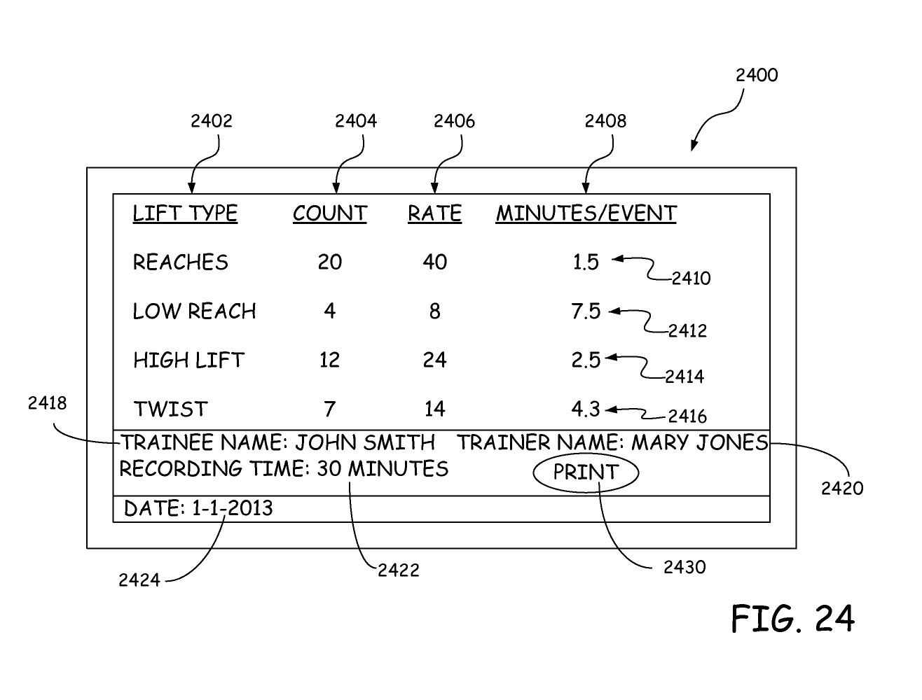

FIG. 24 provides an example 2400 of report 256 of FIG. 2. Report 2400 includes LIFT TYPE column 2402, COUNT column 2404, RATE column 2406 and MINUTES/EVENT column 2408. LIFT TYPE column 2402 lists various lift faults, COUNT column 2404 provides the number of lift faults of each lift type determined during the training session, RATE column 2406 indicates the number of lift faults per hour for each lift type and MINUTES/EVENT column 2408 provides the average number of minutes between lift faults of each lift type.

In row 210, report 2400 indicates that during the training session twenty overreaches were detected at a rate of forty per hour and with an average of 1.5 minutes between overreaches. Row 2412 indicates that four low reaches were detected at a rate of eight per hour with an average of 7.5 minutes between low reaches. Row 2414 indicates that twelve high lifts were detected at a rate of twenty-four per hour with an average of 2.5 minutes between high lifts. Row 2416 indicates that seven twists were detected at a rate of fourteen twists per hour with an average of 4.3 minutes between twists.

Report 2400 also includes a trainee name 2418, a trainer name 2420, a recording time 2422 and a recording date 2424. Trainee name 2418, trainer name 2420, recording time 2422 and date time 2424 are retrieved by report generator 258 from session records 260. The data in columns 2404, 2406 and 2408 is retrieved from reach records 242, high lift records 244, low reach records 246 and twist records 248.

Report 2400 also includes a print control 2430 that when activated causes the content of report 2400 to be printed on a printer (not shown). Such a printer may be present on the cart 114 and may be powered by power supply 110.

Using report 2400, the trainee is provided with feedback that describes how well they avoided various lift faults during the training session. For additional feedback, a training session video 270 created from a video signal generated by RGB sensor 208 and requested by training application 226 using 3-D position API 224 may be shown on display 112 so that the trainee may see how they executed various lifts.

Computing Device

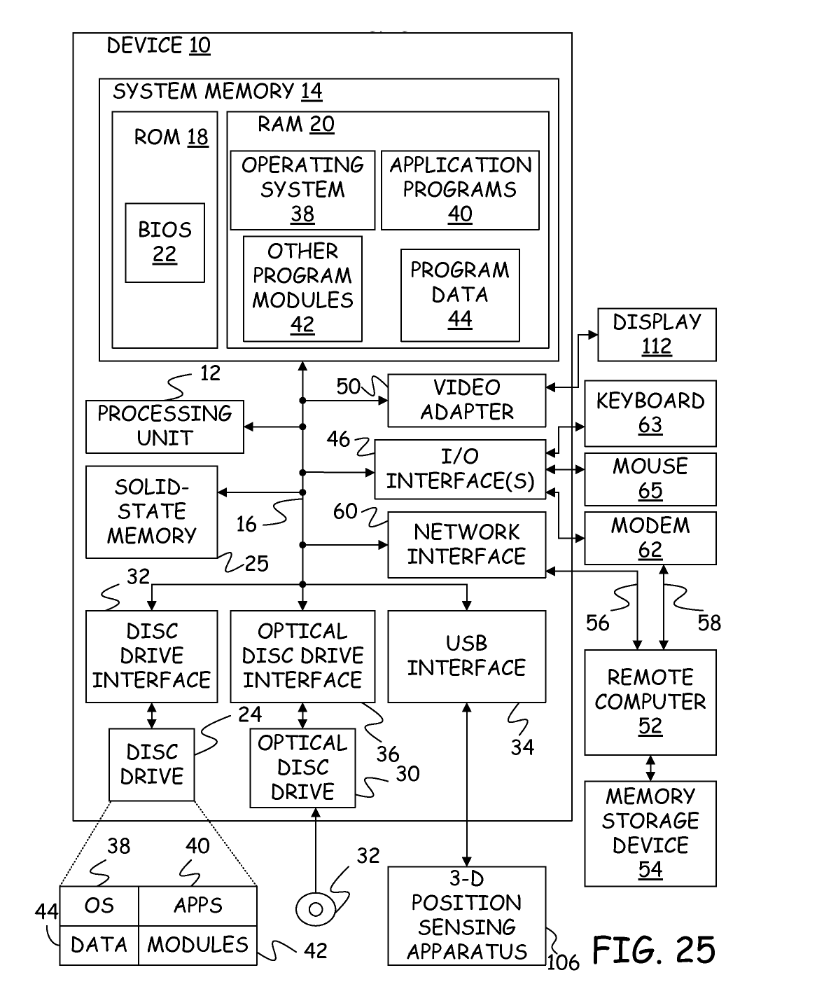

An example of a computing device that can be used as computing device 108 in the various embodiments is shown in the block diagram of FIG. 25. The computing device 10 of FIG. 25 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, and an optical disc drive 30. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile computer-readable storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions representing position detector driver 222, 3D position API 224, training application 226, reach module 234, high lift module 236, low reach module 238, twist module 240, report generator 258 and training user interface generator 254. Program data 44 can include frame event 230, position information 232, reach records 242, high lift records 244, low reach records 246, twist records 248, session records 260, training UI 228, and report 256.

Input devices including a keyboard 63 and a mouse 65 are connected to system bus 16 through an Input/Output interface 46 that is coupled to system bus 16. Display 112 is connected to the system bus 16 through a video adapter 50 and provides graphical images to users. Other peripheral output devices (e.g., speakers or printers) could also be included but have not been illustrated. In accordance with some embodiments, display 112 comprises a touch screen that both displays input and provides locations on the screen where the user is contacting the screen.

Three-dimensional position sensing device 106 is attached to computing device 10 through an interface such as Universal Serial Bus interface 34, which is connected to system bus 16.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 25. The network connections depicted in FIG. 25 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 25 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving locations of a person's hand, shoulder and hip in three-dimensional space from a three-dimensional position sensing device;
determining a shortest distance from the location of the person's hand to a line between the location of the person's shoulder and the location of the person's hip;
comparing the shortest distance to a threshold to determine if the person is overreaching;
when it is determined that the person is overreaching, providing a user interface to indicate that the person was overreaching.

2. The method of claim 1 further comprising:
receiving the location of two points on the person's body from the three-dimensional position sensing device;
determining a distance between the two points; and
setting the threshold based on the distance between the two points.

3. The method of claim 2 wherein one of the two points is the person's wrist and another of the two points is the person's elbow.

4. The method of claim 3 wherein the threshold is set to about one hundred fifty percent of the distance between the person's wrist and the person's elbow.

5. The method of claim 1 further comprising:
determining an angle between a line from the location of the person's hand to the location of the person's shoulder and a line from the location of the person's shoulder to the location of the person's hip;
comparing the angle to a threshold angle to determine if the person is performing a high lift; and
when it is determined that the person is performing a high lift, generating a user interface to indicate that the person performed a high lift.

6. The method of claim 1 further comprising:
receiving locations of the person's knee and foot in three-dimensional space from the three-dimensional position sensing device;
determining an angle between a line from the person's knee to the person's hand and a line from the person's foot to the person's knee;
comparing the angle to a threshold angle to determine if the person is performing a low reach; and
when it is determined that the person is performing a low reach, providing a user interface to indicate that the person performed a low reach.

7. The method of claim 1 further comprising:
receiving locations of the person's other shoulder and other hip in three-dimensional space from a three-dimensional position sensing device;
determining a location of a shoulder midpoint between the person's shoulder and other shoulder;
determining a location of a hip midpoint between the person's hip and other hip;
determining a translated shoulder location using the location of the shoulder midpoint and the location of the hip midpoint;
determining an angle between a line from the location of the hip midpoint to the location of the person's hip and a line from the location of the hip midpoint and the translated shoulder location;
comparing the angle to a threshold angle to determine if the person is twisting; and
when it is determined that the person is twisting, providing a user interface to indicate that the person was twisting.

8. A computer-readable storage medium having computer-executable instructions stored thereon that when executed by a processor cause the processor to perform steps comprising:
receiving three-dimensional coordinates corresponding to a person's left hip, right hip, left shoulder and right shoulder;
performing a translation on the coordinates of at least two of the left hip, the right hip, the left shoulder and the right shoulder to form common plane coordinates for the left hip, the right hip, the left shoulder and the right shoulder, wherein the common plane coordinates are in a common plane;
determining an angle between a line from the common plane coordinates of the left hip to the common plane coordinates of the right hip and a line from the common plane coordinates of the left shoulder to the common plane coordinates of the right shoulder;
comparing the angle to a threshold to determine if the person is twisting; and
when the person is determined to be twisting, recording a twisting event in memory.

9. The computer-readable storage medium of claim 8 wherein performing a translation comprises:
determining three-dimensional coordinates of a shoulder midpoint between the coordinates of the left shoulder and the coordinates of the right shoulder;
determining three-dimensional coordinates of a hip midpoint between the coordinates of the left hip and the coordinates of the right hip;
using the three-dimensional coordinates of the shoulder midpoint and the three-dimensional coordinates of the hip midpoint to determine translation values; and
using the translation values to perform the translation.

10. The computer-readable storage medium of claim 9 wherein performing the translation further comprises:
applying the translation values to the coordinates of the left shoulder to form the common plane coordinates of the left shoulder;
applying the translation values to the coordinates of the right shoulder to form the common plane coordinates of the right shoulder;
using the coordinates of the left hip as the common plane coordinates of the left hip; and
using the coordinates of the right hip as the common plane coordinates of the right hip.

11. The computer-readable storage medium of claim 8 having further computer-executable instructions stored thereon that when executed by the processor cause the processor to perform further steps comprising:
generating a user interface comprising a twisting alert when it is determined that the user is twisting.

12. The computer-readable storage medium of claim 8 having further computer-executable instructions stored thereon that when executed by the processor cause the processor to perform further steps comprising:
receiving three-dimensional coordinates corresponding to the person's left hand;
determining a high lift angle between a line from the three-dimensional coordinates of the left shoulder to the three-dimensional coordinates of the left hand and a line from the three-dimensional coordinates of the left shoulder to the three-dimensional coordinates of the left hip;
comparing the high lift angle to a high lift angle threshold to determine if the person is lifting above their shoulders; and
when the person is determined to be lifting above their shoulders, storing a high lift event in memory.

13. The computer-readable storage medium of claim 8 having further computer-executable instructions stored thereon that when executed by the processor cause the processor to perform further steps comprising:
receiving three-dimensional coordinates corresponding to the person's hand, knee and foot, respectively;
determining a low reach angle between a line from the three-dimensional coordinates of the knee to the three-dimensional coordinates of the hand and a line from the three-dimensional coordinates of the knee to the three-dimensional coordinates of the foot;
comparing the low reach angle to a low reach angle threshold to determine if the person is lifting from below their knee; and
when the person is determined to be lifting from below their knee, storing a low reach event in memory.

14. The computer-readable storage medium of claim 8 having further computer-executable instructions stored thereon that when executed by the processor cause the processor to perform further steps comprising:
receiving three-dimensional coordinates corresponding to the person's left hand;
determining a distance between the left hand and a line from the three-dimensional coordinates of the left shoulder to the three-dimensional coordinates of the left hip;
comparing the distance to a distance threshold to determine if the person is overreaching; and
when the person is determined to be overreaching, storing an overreach event in memory.

15. A system comprising:
a three-dimensional position sensor providing three-dimensional position information for a person's foot, the person's knee, and the person's hand; and
a processor executing instructions to perform steps comprising:
receiving the three-dimensional position information for the person's foot, the person's knee and the person's hand;
using the three-dimensional position information for the person's foot, the person's knee and the person's hand to determine an angle between a line from the person's knee to the person's foot and a line from the person's knee to the person's hand;
determining if the angle indicates that the person is executing a low reach; and
when it is determined that the angle indicates that the person is executing a low reach, storing an indication that the person has executed a low reach in memory.

16. The system of claim 15 further comprising a display wherein the processor further performs a step of generating a user interface for the display to indicate that the person has executed a low reach.

17. The system of claim 15 wherein:
the three-dimensional position sensor further provides three-dimensional position information for the person's hip and the person's shoulder; and
the processor executes instructions to perform further steps comprising:
receiving the three-dimensional position information for the person's hip and the person's shoulder;
using the three-dimensional position information for the person's hip, the person's shoulder and the person's hand to determine a hip-shoulder-hand angle between a line from the person's shoulder to the person's hip and a line from the person's shoulder to the person's hand;
determining if the hip-shoulder-hand angle indicates that the person is executing a high lift; and
when it is determined that the hip-shoulder-hand angle indicates that the person is executing a high lift, storing an indication that the person has executed a high lift in memory.

18. The system of claim 15 wherein:
the three-dimensional position sensor further provides three-dimensional position information for the person's hip and the person's shoulder; and
the processor executes instructions to perform further steps comprising:
receiving the three-dimensional position information for the person's hip and the person's shoulder;
using the three-dimensional position information for the person's hip, the person's shoulder and the person's hand to determine a reach distance from the person's hand to a line from the person's shoulder to the person's hip;
determining if the reach distance indicates that the person is executing an excessive reach; and
when it is determined that the reach distance indicates that the person is executing an excessive reach, storing an indication that the person has executed a excessive reach in memory.

19. The system of claim 18 wherein:
the three-dimensional position sensor further provides three-dimensional position information for the person's elbow and the person's wrist; and
the processor executes instructions to perform further steps comprising:
receiving the three-dimensional position information for the person's elbow and the person's wrist;
using the three-dimensional position information for the person's elbow and the person's wrist to determine a reach standard; and
wherein determining if the reach distance indicates that the person is executing an excessive reach comprises comparing the reach distance to a value formed from the reach standard.

20. The system of claim 15 wherein:
the three-dimensional position sensor further provides three-dimensional position information for the person's left hip, the person's right hip, the person's left shoulder and the person's right shoulder; and
the processor executes instructions to perform further steps comprising:
receiving the three-dimensional position information for the person's left hip, the person's right hip, the person's left shoulder and the person's right shoulder;
using the three-dimensional position information for the person's left hip, the person's right hip, the person's left shoulder and the person's right shoulder to determine a twist angle between a line from the person's left hip to the person's right hip and a line from the person's left shoulder to the person's right shoulder;
determining if the twist angle indicates that the person is executing an excessive twist; and
when it is determined that the twist angle indicates that the person is executing an excessive twist, storing an indication that the person has executed an excessive twist in memory.
